(19) United States
(12) Patent Application Publication
(10) Pub. No.: US 2025/0256439 A1
(43) Pub. Date: Aug. 14, 2025

(54) VERTICAL MOLD CLAMPING DEVICE AND VERTICAL INJECTION MOLDING MACHINE

(71) Applicant: THE JAPAN STEEL WORKS, LTD., Tokyo (JP)

(72) Inventor: Kiyotaka NAKAYAMA, Tokyo (JP)

(21) Appl. No.: 19/045,156

(22) Filed: Feb. 4, 2025

(30) Foreign Application Priority Data
Feb. 8, 2024 (JP) 2024-017615

(51) Int. Cl. B29C 45/17; B29C 45/04

(52) U.S. Cl. CPC B29C 45/1744; B29C 45/0408; B29C 45/1761

(57) ABSTRACT

A vertical mold clamping device includes a fixed platen, an upper movable platen provided above the fixed platen, a lower movable platen provided below the fixed platen, a plurality of tie bars penetrating the fixed platen and each having an upper end portion fixed to the upper movable platen by a tie bar nut and a lower end portion coupled to the lower movable platen, a mold clamping mechanism provided between the fixed platen and the lower movable platen, and a rotary table rotatably provided on an upper surface of the fixed platen. One of the tie bars is a center tie bar penetrating the rotary table. The center tie bar is fixed by the tie bar nut in a state of being attached to the upper movable platen via a detachable sleeve having a predetermined thickness.

### CROSS-REFERENCE TO RELATED APPLICATIONS

This application is based on and claims priority under 35 USC 119 from Japanese Patent Application No. 2024-017615 filed on Feb. 8, 2024, the entire content of which is incorporated herein by reference.

### TECHNICAL FIELD

The present disclosure relates to a vertical mold clamping device including a rotary table that rotates about a center tie bar, and a vertical injection molding machine.

### BACKGROUND

A vertical injection molding machine includes a vertical mold clamping device that is opened and closed in an upper-lower direction and an injection device. The vertical mold clamping device includes a fixed platen fixed to a frame, an upper movable platen provided above the fixed platen, and a lower movable platen provided below the fixed platen. The upper movable platen and the lower movable platen are coupled by a plurality of tie bars, and a mold clamping mechanism is provided between the lower movable platen and the fixed platen. In the case of a vertical injection molding machine including a rotary table, the rotary table is provided on a fixed platen and rotates about one tie bar, that is, a center tie bar.

When supplying a fluid to a mold for the purpose of heating, cooling, or the like, a fluid supply device is required. In the case of a vertical injection molding machine including a rotary table, the fluid supply device is often provided on the rotary table and penetrated by a center tie bar as described in, for example, JPH07-40119U. Such a fluid supply device generally includes a cylindrical supply cylinder provided concentrically with the center tie bar and fixed to a fixed platen or an upper movable platen, and a cylindrical distribution cylinder provided outside the supply cylinder and configured to slide with respect to the supply cylinder. The distribution cylinder is fixed to the rotary table and rotates together with the rotary table. A predetermined flow path is formed in the supply cylinder and the distribution cylinder, a fluid supplied from the supply cylinder is sent to a mold via the distribution cylinder regardless of a rotation position of the rotary table, and a fluid discharged from the mold is returned to the supply cylinder via the distribution cylinder.

### SUMMARY

In the fluid supply device, since the distribution cylinder rotates with respect to the supply cylinder, a plurality of annular seals are provided on sliding surfaces of the supply cylinder and the distribution cylinder to prevent leakage of a liquid. Since the seals deteriorate over long periods of operation, periodical replacement is required. The annular seal is provided between the supply cylinder and the distribution cylinder, which are penetrated by the center tie bar, and therefore is necessarily penetrated by the center tie bar. That is, when a new seal is attached, it is necessary to insert the seal from an end portion of the center tie bar so as to penetrate the center tie bar. To insert the seal in this manner, the upper movable platen gets in the way. Thus, it is necessary to remove the upper movable platen to expose the end portion of the center tie bar. That is, when a vertical injection molding machine includes a fluid supply device of a type that is penetrated by a center tie bar, there is a problem in that a large amount of work is required to replace the seal, resulting in high maintenance costs.

The present disclosure provides a vertical mold clamping device in which a seal of a fluid supply device can be easily replaced even when the fluid supply device is provided.

Other problems and novel features will become apparent from description of the present description and the accompanying drawings.

A vertical mold clamping device includes a fixed platen, an upper movable platen provided above the fixed platen, a lower movable platen provided below the fixed platen, a plurality of tie bars penetrating the fixed platen and each having an upper end portion fixed to the upper movable platen by a tie bar nut and a lower end portion coupled to the lower movable platen, a mold clamping mechanism provided between the fixed platen and the lower movable platen, and a rotary table rotatably provided on an upper surface of the fixed platen. One of the tie bars is a center tie bar penetrating the rotary table. The center tie bar is fixed by the tie bar nut in a state of being attached to the upper movable platen via a detachable sleeve having a predetermined thickness.

According to the present disclosure, when a fluid supply device is provided, a seal of the fluid supply device can be easily replaced.

### BRIEF DESCRIPTION OF DRAWINGS

FIG. 1 is a front view of a vertical injection molding machine according to a first illustrative embodiment.

FIG. 2 is a side sectional view showing a part of the vertical mold clamping devices and a fluid supply device according to the first illustrative embodiment.

FIG. 3A is a perspective view showing an upper movable platen and a sleeve according to the first illustrative embodiment.

FIG. 3B is a perspective view showing a part of the vertical mold clamping device according to the first illustrative embodiment.

FIG. 4A is a perspective view showing a part of the vertical mold clamping device according to the first illustrative embodiment.

FIG. 4B is a perspective view showing a part of the vertical mold clamping device according to the first illustrative embodiment.

FIG. 4C is a perspective view showing a part of the vertical mold clamping device according to the first illustrative embodiment.

FIG. 4D is a perspective view showing a part of the vertical mold clamping device according to the first illustrative embodiment.

FIG. 5A is a perspective view showing an upper movable platen, a sleeve, and a closing member according to a modification of the first illustrative embodiment.

FIG. 5B is a perspective view showing a part of the upper movable platen according to the modification of the first illustrative embodiment.

FIG. 5C is a perspective view showing a part of a vertical mold clamping device according to the modification of the first illustrative embodiment.

FIG. 6 is a side view of a vertical injection molding machine according to a second illustrative embodiment.

FIG. 7A is a top view of the vertical mold clamping device according to the second illustrative embodiment.

FIG. 7B is a top view showing a part of the vertical mold clamping device according to the second illustrative embodiment.

### DETAILED DESCRIPTION

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### First Illustrative Embodiment

### {Vertical Injection Molding Machine}

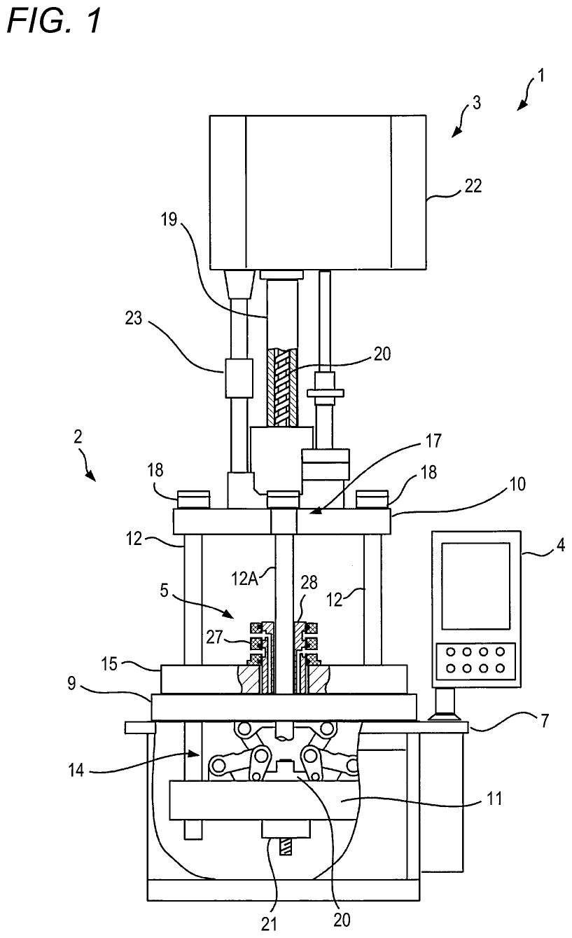

As shown in FIG. 1, a vertical injection molding machine 1 according to a first illustrative embodiment includes: a mold clamping device of a vertical type, that is, a vertical mold clamping device 2; an injection device 3 provided above the vertical mold clamping device 2; a control device 4 configured to control these devices; and a fluid supply device 5 configured to supply a fluid to a mold.

### {Vertical Mold Clamping Device}

The vertical mold clamping device 2 includes a fixed platen 9 fixed to a bed 7, an upper movable platen 10 provided above the fixed platen 9, and a lower movable platen 11 provided in the bed 7. In the present illustrative embodiment, the upper movable platen 10 and the lower movable platen 11 are coupled by three tie bars 12A, 12, . . . . A mold clamping mechanism, that is, a toggle mechanism 14 in the present illustrative embodiment, is provided between the lower movable platen 11 and the fixed platen 9.

A rotary table 15 is provided on the fixed platen 9. The rotary table 15 rotates about one tie bar 12A at the center in FIG. 1. The tie bar 12A is disposed at the center of the rotary table 15, and is therefore referred to as a center tie bar 12A. A coupling structure 17 between the center tie bar 12A and the upper movable platen 10, that is, the coupling structure 17 according to the present illustrative embodiment is different from coupling structures 18 and 18 between other tie bars 12 and 12 and the upper movable platen 10, and is a characteristic structure in the first illustrative embodiment. This will be described later. The fluid supply device 5 is provided on the fixed platen 9 and the rotary table 15, which will be described later.

### {Injection Device}

The injection device 3 is provided above the upper movable platen 10. The injection device 3 includes a heating cylinder 19, a screw 20 provided in the heating cylinder 19, a screw driving mechanism 22 configured to drive the screw 20, and a lifting-lowering device 23 configured to lift and lower the entire injection device 3. In the injection device 3, the screw 20 is rotated to melt an injection material, and the screw 20 is driven in an axial direction to inject the injection material.

### {Fluid Supply Device}

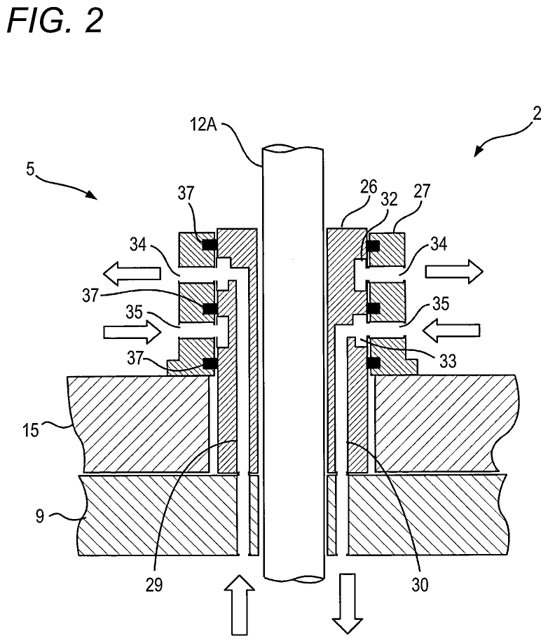

In the present illustrative embodiment, the fluid supply device 5 is penetrated by the center tie bar 12A as shown in FIG. 2. As long as the fluid supply device 5 is of a type that is penetrated by the center tie bar 12A in this manner, the effects of the present disclosure can be achieved regardless of the configuration. Here, the fluid supply device 5 shown in FIG. 2 will be described as an example of a type that is penetrated by the center tie bar 12A.

The fluid supply device 5 schematically includes a cylindrical supply cylinder 26 provided to surround the center tie bar 12A and fixed to the fixed platen 9, and a cylindrical distribution cylinder 27 provided outside the supply cylinder 26 and fixed to the rotary table 15. The supply cylinder 26 has a fluid supply flow path 29 and a fluid discharge flow path 30 formed therein. The supply cylinder 26 is designed to allow a fluid supplied from the outside to be supplied through the fluid supply flow path 29, and a fluid to be discharged to the outside through the fluid discharge flow path 30. Two annular grooves, that is, a supply annular groove 32 and a discharge annular groove 33 are formed on an outer peripheral surface of the supply cylinder 26. The fluid supply flow path 29 communicates with the supply annular groove 32, and the fluid discharge flow path 30 communicates with the discharge annular groove 33.

An inner peripheral surface of the distribution cylinder 27 is in contact with the outer peripheral surface of the supply cylinder 26, and when the rotary table 15 rotates, the distribution cylinder 27 slidably rotates with respect to the supply cylinder 26. The distribution cylinder 27 is formed with two fluid supply ports 34 and 34 which are through holes opened in a radial direction, and similarly, with two fluid discharge ports 35 and 35 which are through holes opened in the radial direction. Regardless of a rotation position of the distribution cylinder 27, the two fluid supply ports 34 and 34 always communicate with the supply annular groove 32, and the two fluid discharge ports 35 and 35 always communicate with the discharge annular groove 33. Therefore, although not shown, in a case where a mold is provided on the rotary table 15, a fluid can be supplied to the mold and discharged from the mold regardless of the rotation position of the rotary table 15.

A plurality of annular seals 37, 37, . . . are provided between the distribution cylinder 27 and the supply cylinder 26 to prevent leakage of a liquid. Since these seals 37, 37, . . . deteriorate over long periods of operation, periodical replacement is required.

### {Coupling Structure}

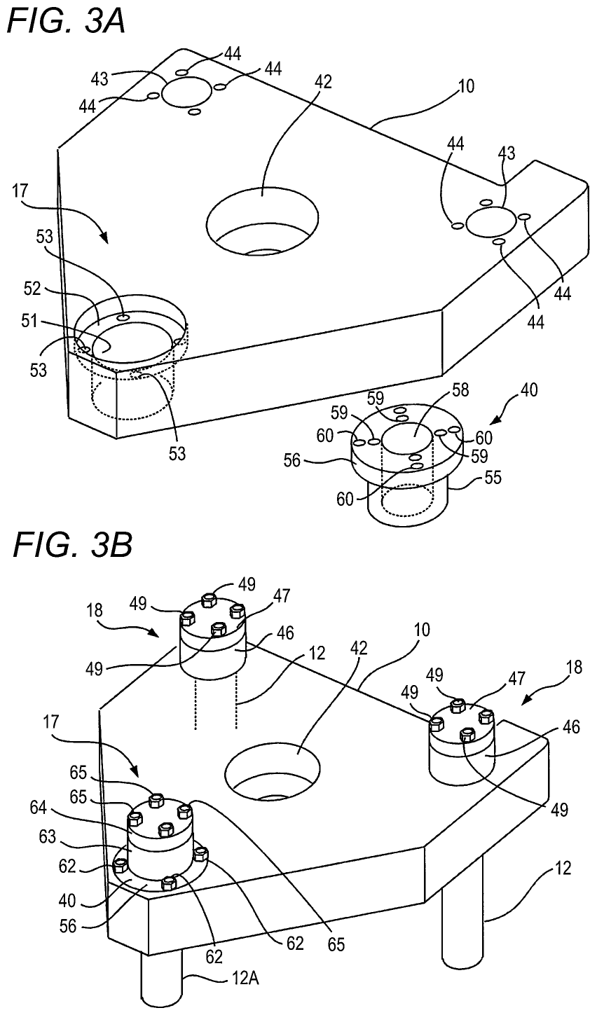

The coupling structures 17, 18, 18 that connect the upper movable platen 10 (see FIG. 1) and the tie bars 12A, 12, . . . will be described. FIG. 3A shows the upper movable platen 10 and a sleeve 40, which is one of the components of the coupling structure 17. FIG. 3B shows a state in which the upper movable platen 10 and the tie bars 12A, 12, . . . are coupled by the coupling structures 17, 18, 18.

First, a commonly used coupling structure 18, 18 will be described. As shown in FIG. 3A, the upper movable platen 10 has an opening 42 at the center into which an injection nozzle (not shown) of the injection device 3 (see FIG. 1) is inserted, and two tie bar holes 43 and 43 on the left and right sides. A plurality of tapped holes 44 and 44 are formed around each of the tie bar holes 43 and 43. As shown in FIG. 3B, upper ends of the tie bars 12 and 12 are inserted into the tie bar holes 43 and 43, tie bar nuts 46 and 46 are screwed onto the tie bars, and then tie bar covers 47 and 47 are installed. Although not shown in the drawings, the tie bar covers 47 and 47 and the tie bar nuts 46 and 46 have bolt holes that pass through them, and bolts 49, 49, . . . are inserted and tightened. In this way, the tie bars 12 and 12 are fixed to the upper movable platen 10. The coupling structures 18 and 18 of the tie bars 12 and 12 and the upper movable platen 10 are configured as described above.

Next, the coupling structure 17 according to the first illustrative embodiment will be described. As shown in FIG. 3A, a through hole 51 having a relatively large diameter is formed at a tip end of the upper movable platen 10. An upper side of the through hole 51 is expanded in diameter, thereby forming an annular step portion 52. A plurality of tapped holes 53, 53, . . . are formed in the step portion 52.

The sleeve 40 includes a body portion 55 having an outer diameter slightly smaller than an inner diameter of the through hole 51, and a flange portion 56 having an enlarged diameter and formed on the body portion 55. A tie bar hole 58 is formed at the center of the sleeve 40. The flange portion 56 has a plurality of tapped holes 59, 59, . . . on a radially inner side, and is formed with a plurality of penetrating bolt holes 60, 60, . . . on a radially outer side.

When the sleeve 40 is inserted from above into the through hole 51 of the upper movable platen 10, the body portion 55 is smoothly inserted into the through hole 51, and the flange portion 56 is placed on the step portion 52. As shown in FIG. 3B, the sleeve 40 is fixed to the upper movable platen 10 when the bolts 62, 62, . . . are tightened.

A tip end of the center tie bar 12A is inserted into the tie bar hole 58 of the sleeve 40, the tie bar nut 63 is screwed onto the center tie bar 12A, and then a tie bar cover 64 is installed. Although not shown in the drawings, the tie bar cover 64 and the tie bar nut 63 have penetrating bolt holes. When a plurality of bolts 65,65, . . . are inserted and tightened, the center tie bar 12A is fixed to the sleeve 40. That is, the center tie bar 12A is fixed to the upper movable platen 10. The coupling structure 17 according to the first illustrative embodiment is configured as described above, and is characterized in that the upper movable platen 10 and the center tie bar 12A are coupled via the sleeve 40.

### {Method for Replacing Seal}

A method for replacing the seals 37, 37, . . . in the fluid supply device 5 (see FIG. 2) will be described. In the fluid supply device 5, the coupling between the distribution cylinder 27 and the rotary table 15 is released. Next, the distribution cylinder 27 is pulled out upward. Then, the distribution cylinder 27 is separated from the supply cylinder 26. The seals 37, 37, . . . are exposed and are removed from the distribution cylinder 27. The seals 37, 37, . . . are penetrated by the center tie bar 12A, but can be easily removed by cutting. To install a new seal, the new seal needs to be passed through from the tip end of the center tie bar 12A and moved to the vicinity of the distribution cylinder 27. This is performed as follows.

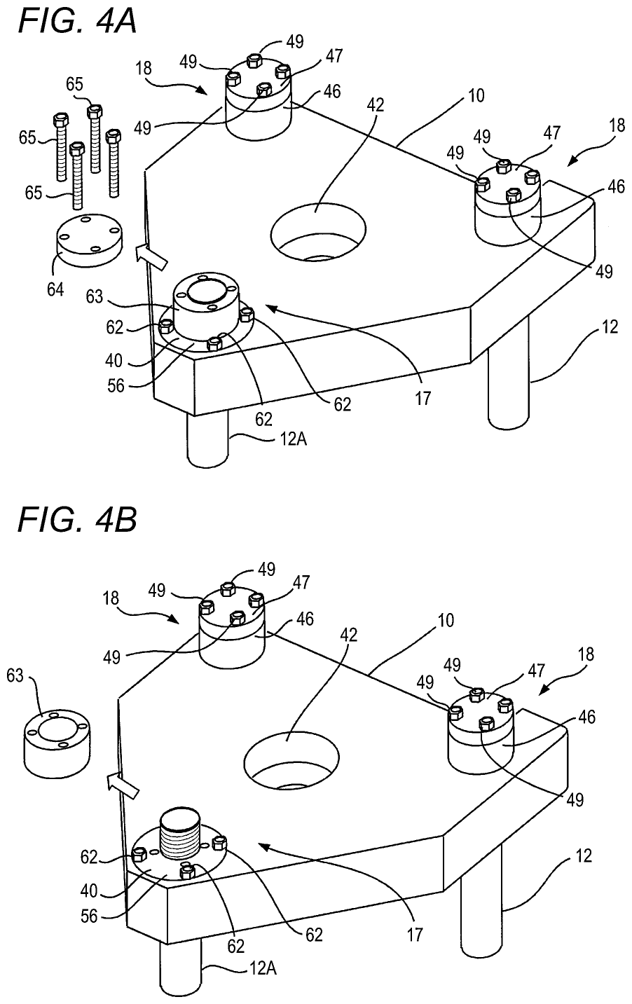

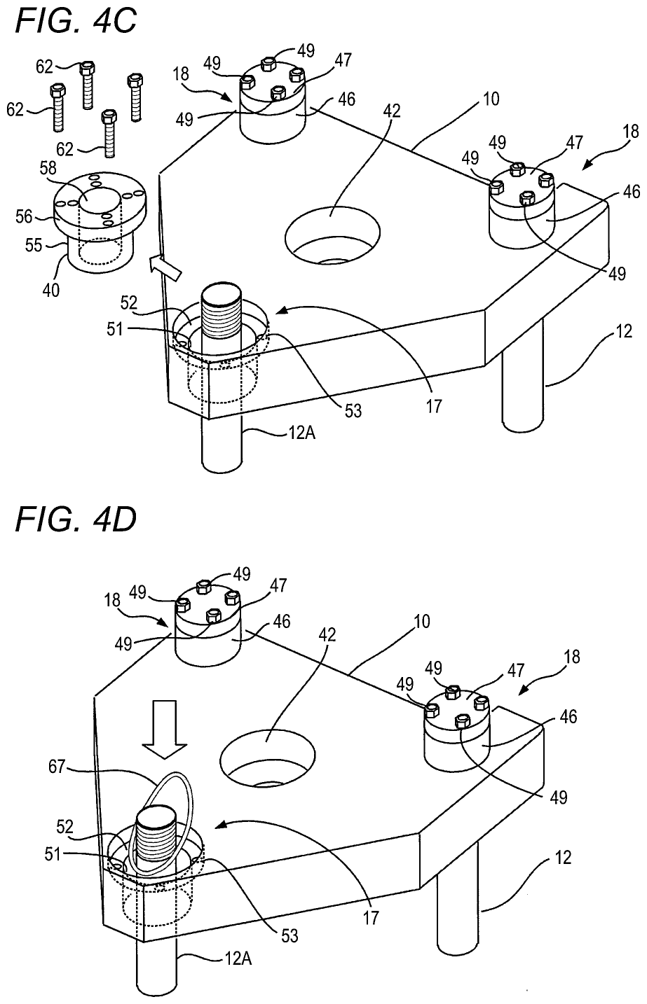

First, as shown in FIG. 4A, the bolts 65, 65, . . . are removed from the coupling structure 17 according to the first illustrative embodiment. Then, the tie bar cover 64 can be removed. Next, when the tie bar nut 63 is loosened, it can be removed as shown in FIG. 4B. The bolts 62, 62, . . . fixing the sleeve 40 are removed, and the sleeve 40 is pulled out. Then, as shown in FIG. 4C, an annular gap having a predetermined width is formed between the center tie bar 12A and the through hole 51. As shown in FIG. 4D, a new seal 67 is inserted from the upper end of the center tie bar 12A. The seal 67 can be moved downward through the annular gap. Similarly, a plurality of new seals are inserted downward along the center tie bar 12A.

After a new seal is attached to the distribution cylinder 27 (see FIG. 2), the distribution cylinder 27 is inserted into the supply cylinder 26. The distribution cylinder 27 is fixed to the rotary table 15. The replacement of the seal is completed. To assemble the coupling structure 17 (see FIG. 3B) according to the present illustrative embodiment and couple the center tie bar 12A and the upper movable platen 10, the above-described steps are carried out in reverse order. In the vertical mold clamping device 2 (see FIG. 1) according to the first illustrative embodiment, the center tie bar 12A is coupled to the upper movable platen 10 by the coupling structure 17 including the sleeve 40 (see FIG. 3A), so that a seal of the fluid supply device 5 can be easily replaced by removing the sleeve 40.

### Modification to First Illustrative Embodiment

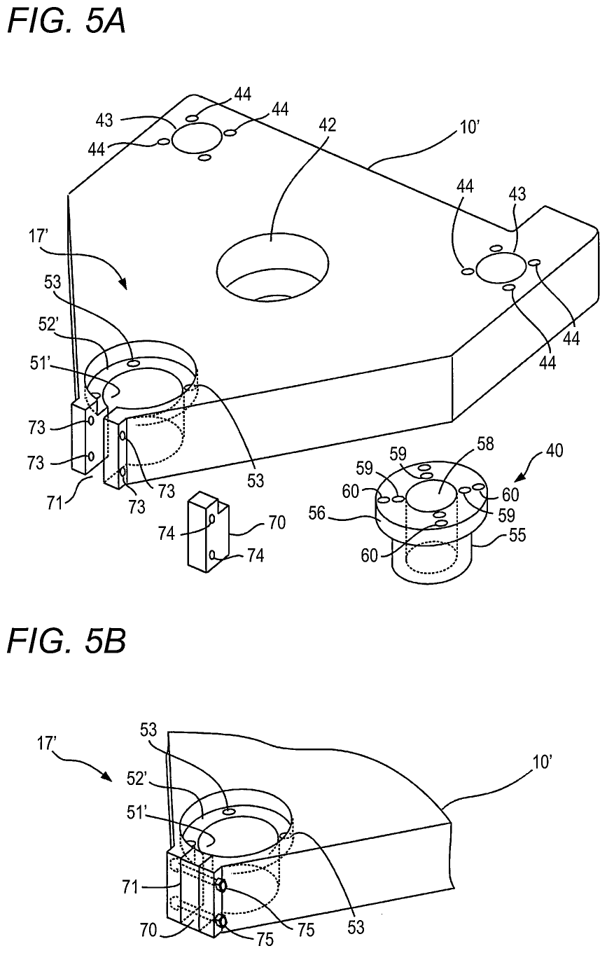

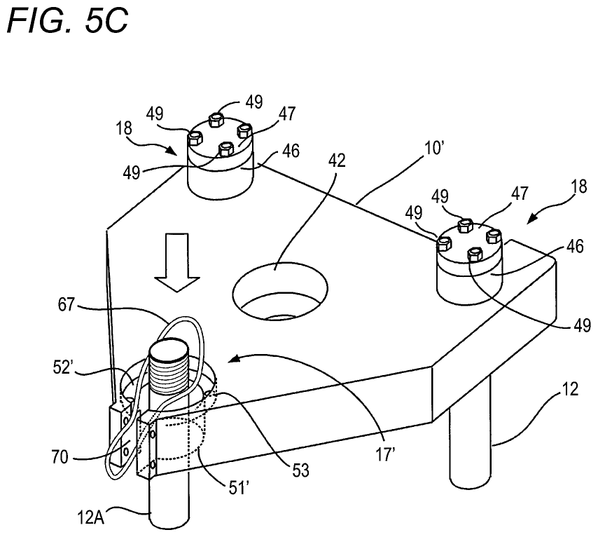

The first illustrative embodiment can be variously modified. For example, the coupling structure 17 according to the first illustrative embodiment may be modified to a coupling structure 17′ according to a modification. FIG. 5A shows an upper movable platen 10′, the sleeve 40, and a closing member 70 according to the modification of the first illustrative embodiment. The upper movable platen 10′ is formed with a slit 71 having a predetermined width extending from a through hole 51′ to a side surface of the upper movable platen 10′. That is, the through hole 51′ opens to the side surface of the upper movable platen 10′ via the slit 71. In the vicinity of the slit 71, penetrating bolt holes 73, 73, . . . are formed.

The closing member 70 is a member specific to the modification of the first illustrative embodiment, is a member to be inserted into the slit 71, and has bolt holes 74 and 74 formed therein. As shown in FIG. 5B, when the closing member 70 is inserted into the slit 71 and fixed to the upper movable platen 10′ by bolts 75 and 75, the slit 71 is completely closed. In this state, the through hole 51′ has substantially the same configuration as the through hole 51 in the first illustrative embodiment described with reference to FIG. 3A. As can be easily understood by those skilled in the art, the sleeve 40 is inserted and fixed in the through hole 51′. Then, as shown in FIG. 3B, when the center tie bar 12A is inserted and the tie bar nut 63 and the tie bar cover 64 are provided and fixed by the bolts 65, 65, . . . , the upper movable platen 10′ and the center tie bar 12A can be coupled to each other.

In the coupling structure 17′ (see FIG. 5A) according to the modification of the first illustrative embodiment, when the sleeve 40 and the closing member 70 are removed, the through hole 51′ opens to the side surface of the upper movable platen 10′ via the slit 71 as described above. Then, as shown in FIG. 5C, when inserting the new seal 67, there is a margin corresponding to a width of the slit 71, so that the seal 67 can be easily inserted.

### Second Illustrative Embodiment

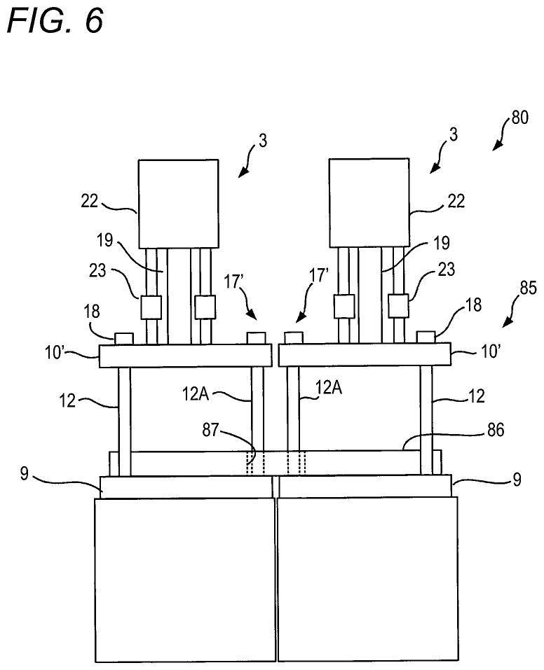

A vertical injection molding machine 80 according to a second embodiment shown in FIG. 6 will be described. The vertical injection molding machine 80 according to the second illustrative embodiment is schematically configured such that two vertical injection molding machines 1 (see FIG. 1) according to the first illustrative embodiment are arranged in parallel. That is, a vertical mold clamping device 85 according to the second illustrative embodiment, which is configured as one unit by combining two vertical mold clamping devices 2 (see FIG. 1) according to the first illustrative embodiment, and two injection devices 3 and 3 according to the first illustrative embodiment are provided. In the vertical injection molding machine 80 according to the second illustrative embodiment, members similar to those of the first illustrative embodiment or members similar to those of the modification of the first illustrative embodiment are denoted by the same reference numerals, and description thereof will be omitted.

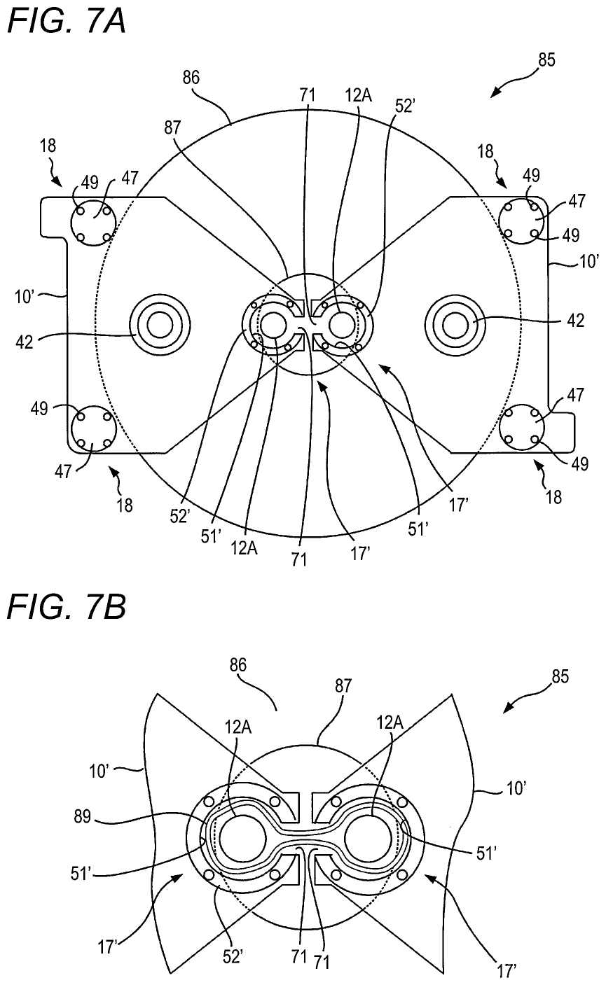

The vertical mold clamping device 85 according to the second illustrative embodiment is a combination of two vertical mold clamping devices 2 (see FIG. 1) according to the first illustrative embodiment, but differs in the following points. That is, one common rotary table 86 is provided over the two fixed platens 9 and 9. As shown in FIG. 7A, the rotary table 86 has a relatively large opening 87 at the center, and the two center tie bars 12A and 12A penetrate the opening 87. Therefore, the rotary table 86 is rotatable about the two center tie bars 12A and 12A. In the vertical mold clamping device 85, the two upper movable platens 10′ and 10′ are configured in the same manner as the upper movable platen 10′ according to the modification of the first illustrative embodiment, and are coupled with the center tie bars 12A and 12A by the coupling structures 17′ and 17′ according to the modification of the first illustrative embodiment.

Although not shown in FIG. 6, when a fluid supply device is provided in the vertical mold clamping device 85 according to the second illustrative embodiment, the fluid supply device is provided in the rotary table 86. The fluid supply device is penetrated by the two center tie bars 12A and 12A. In this way, when replacing a seal provided in the fluid supply device, it is necessary to insert a new seal in a state where the seal penetrates the two center tie bars 12A and 12A.

FIG. 7A shows a state in which the coupling structures 17′ and 17′ according to the modification of the first illustrative embodiment are disassembled in the two upper movable platens 10′ and 10′, and FIG. 7B shows a partially enlarged view thereof. In this state, an annular gap is formed between the center tie bar 12A, 12A and the through hole 51′, 51′, and the center tie bars 12A and 12A face each other via the slits 71 and 71. That is, there is no member that separates the center tie bars 12A and 12A from each other. Therefore, as shown in FIG. 7B, a new seal 89 can be inserted while being penetrated by the two center tie bars 12A and 12A.

Although the invention made by the present inventor has been specifically described above based on the illustrative embodiments, it is needless to say that the present invention is not limited to the illustrative embodiments described above, and various modifications can be made without departing from the scope of the invention. The plurality of examples described above may be appropriately combined.

What is claimed is:

1. A vertical mold clamping device comprising:
a fixed platen;
an upper movable platen provided above the fixed platen;
a lower movable platen provided below the fixed platen;
a plurality of tie bars penetrating the fixed platen and each having an upper end portion fixed to the upper movable platen by a tie bar nut and a lower end portion coupled to the lower movable platen;
a mold clamping mechanism provided between the fixed platen and the lower movable platen; and
a rotary table rotatably provided on an upper surface of the fixed platen,
wherein one of the tie bars is a center tie bar penetrating the rotary table, and
wherein the center tie bar is fixed by the tie bar nut in a state of being attached to the upper movable platen via a detachable sleeve having a predetermined thickness.

2. The vertical mold clamping device according to claim 1, further comprising:
a fluid supply device configured to supply a fluid to a mold,
wherein the fluid supply device is provided on the rotary table and is penetrated by the center tie bar.

3. The vertical mold clamping device according to claim 1, wherein the number of the tie bars is three.

4. The vertical mold clamping device according to claim 1, wherein a flange portion is formed on the sleeve.

5. The vertical mold clamping device according to claim 4, wherein the sleeve is fixed to the upper movable platen by fixing the flange portion to the upper movable platen by a fastener.

6. The vertical mold clamping device according to claim 4, wherein a through hole formed in the upper movable platen and into which the sleeve is inserted is formed with a step portion having an enlarged diameter at an upper portion, and the flange portion is placed on the step portion.

7. The vertical mold clamping device according to claim 1, wherein a through hole formed in the upper movable platen and into which the sleeve is inserted is formed with a slit having a predetermined width that reaches a side surface of the upper movable platen, and opens to the side surface.

8. The vertical mold clamping device according to claim 7, wherein a closing member configured to close the slit is detachably provided in the slit.

9. The vertical mold clamping device according to claim 2,
wherein the fluid supply device includes:
a cylindrical supply cylinder disposed to surround the center tie bar and fixed to the fixed platen; and
a cylindrical distribution cylinder disposed outside the supply cylinder and fixed to the rotary table, and
wherein an annular leakage-prevention seal is provided between the distribution cylinder and the supply cylinder.

10. The vertical mold clamping device according to claim 9,
wherein a fluid supply flow path for supplying the fluid from an outside and a fluid discharge flow path for discharging the fluid to the outside are formed in the supply cylinder,
wherein the distribution cylinder is formed with a fluid supply port communicating with the supply flow path and a fluid discharge port communicating with the discharge flow path, and
wherein an inner peripheral surface of the distribution cylinder faces an outer peripheral surface of the supply cylinder, and the distribution cylinder is slidably rotatable with respect to the supply cylinder when the rotary table rotates.

11. A vertical injection molding machine comprising:
a vertical mold clamping device; and
an injection device provided above the vertical mold clamping device and configured to inject an injection material,
wherein the vertical mold clamping device includes:
a fixed platen;
an upper movable platen provided above the fixed platen;
a lower movable platen provided below the fixed platen;
a plurality of tie bars penetrating the fixed platen and each having an upper end portion fixed to the upper movable platen by a tie bar nut and a lower end portion coupled to the lower movable platen;
a mold clamping mechanism provided between the fixed platen and the lower movable platen; and
a rotary table rotatably provided on an upper surface of the fixed platen,
wherein one of the tie bars is a center tie bar penetrating the rotary table, and
wherein the center tie bar is fixed by the tie bar nut in a state of being attached to the upper movable platen via a detachable sleeve having a predetermined thickness.

12. The vertical injection molding machine according to claim 11,
wherein the vertical mold clamping device includes a fluid supply device configured to supply a fluid to a mold, and
wherein the fluid supply device is provided on the rotary table and is penetrated by the center tie bar.

13. The vertical injection molding machine according to claim 11, wherein the number of the tie bars is three.

14. The vertical injection molding machine according to claim 11, wherein a flange portion is formed on the sleeve.

15. The vertical injection molding machine according to claim 14, wherein the sleeve is fixed to the upper movable platen by fixing the flange portion to the upper movable platen by a fastener.

16. The vertical injection molding machine according to claim 14, wherein a through hole formed in the upper movable platen and into which the sleeve is inserted is formed with a step portion having an enlarged diameter at an upper portion, and the flange portion is placed on the step portion.

17. The vertical injection molding machine according to claim 11, wherein a through hole formed in the upper movable platen and into which the sleeve is inserted is formed with a slit having a predetermined width that reaches a side surface of the upper movable platen, and opens to the side surface.

18. The vertical injection molding machine according to claim 17, wherein a closing member configured to close the slit is detachably provided in the slit.

19. The vertical injection molding machine according to claim 11,
wherein the injection device includes a heating cylinder, a screw provided in the heating cylinder, and a screw driving mechanism configured to drive the screw, the injection device being configured to rotate the screw to melt the injection material and to drive the screw in an axial direction to inject the injection material, and
wherein the injection device is provided above the upper movable platen.
